(19) United States
(12) Patent Application Publication
(10) Pub. No.: US 2018/0295692 A1
(43) Pub. Date: Oct. 11, 2018

(54) A SYSTEM AND METHOD TO REGULATE PRIMARY SIDE CURRENT USING AN EVENT DRIVEN ARCHITECTURE IN LED CIRCUIT

(71) Applicant: GLOBALFOUNDRIES INC., Grand Cayman, KY (US)

(72) Inventors: Abhisek KHARE, Bangalore (IN); Somnath SAMANTHA, Bangalore (IN); Krishnadas BHAGWAT, Bangalore (IN); Sumon K BOSE, Bangalore (IN); Hrishikesh BHAGWAT, Bangalore (IN); Rajesh SWAMINATHAN, Bangalore (IN); Ramesh G KARPUR, Bangalore (IN)

(21) Appl. No.: 15/531,460

(22) PCT Filed: Nov. 29, 2015
(86) PCT No.: PCT/IB15/59192

§ 371 Date: May 29, 2017

(30) Foreign Application Priority Data
Nov. 29, 2014 (IN) 5988/CHE/2014

(51) Int. Cl. H05B 33/08

(52) U.S. Cl. CPC H05B 33/0851; H05B 33/0818

(57) ABSTRACT

The present invention discloses a system and method to regulate primary side current using an event driven architecture in led circuit. The system (100) performs a primary side regulation (PSR) of isolated or non-isolated LED driver topology such as fly back system. The primary side peak voltage/current is regulated to achieve desired secondary side currents without the need of additional external components. The architecture combines firmware and hardware to realize PSR. The method (200) may effectively combine input wave shaping (Active PFC), dimming and PSR to achieve accurate secondary side currents. The method (200) corrects the Peak Regulation Voltage/current (PRV) of primary loop to meet desired half cycle reference voltage/current, which in turn achieves the desired secondary loop current in led circuit.

### TECHNICAL FIELD OF THE INVENTION

The present invention relates to a system to achieve accurate primary side regulation (PSR), Power Factor Correction (PFC), dimming functionality without the need of external components. More particularly, the present invention relates to a method that corrects the PRV/current of primary loop to meet desired half cycle reference voltage/current, which in turn achieves the desired secondary loop currents in led circuit.

### BACKGROUND OF THE INVENTION

LEDs are current-driven devices. LEDs are used in a various kinds of electronic applications such as architectural lighting, automotive head and tail lights, backlights for liquid crystal display devices including personal computers and high definition TVs, flashlights, etc. A LED driver circuit generally requires a constant direct current (DC), which is fed to a LED load. The LEDs have significant advantages such as high efficiency, good directionality, color stability, high reliability, long life time, small size, and environmental safety. The lumen output intensity (i.e. brightness) of the LED approximately varies in direct proportion to the current flowing through the LED. Thus, increasing current supplied to an LED increases the intensity of the LED and decreasing current supplied to the LED dims the LED. The current may be modified by either directly reducing the direct current level to the LEDs or by reducing the average current through duty cycle modulation. For power supply applications, such as a battery charger or light emitting diode (LED) ballast, the power supply should provide a constant current. If load resistance is above this value, the output voltage needs to be constant.

Various types of conventional driver circuits that regulate the primary side current are known in the prior art. The U.S. Pat. No. 7,525,259 B2 describes a primary side regulated power supply system with constant current output. The claimed power supply system has a primary side and a secondary side. An input terminal on the primary side is operable to receive an input voltage. An output terminal on the secondary side is operable to be connected to a load for providing current thereto. Circuitry is provided which is operable to regulate the power supply system from the primary side so that the current provided to the load at the output terminal is substantially constant.

The U.S. Pat. No. 9,083,252 B2 describes the primary-side regulation for isolated power supplies. The claimed DC-DC converter includes a primary side sense circuit to detect a load current of the DC-DC converter based on reflected current from a secondary winding of the DC-DC converter to a primary winding of the DC-DC converter. A primary side diode models effects of a secondary side diode that is driven from the secondary winding of the DC-DC converter. An output correction circuit controls a switching waveform to the primary winding of the DC-DC converter based on feedback from the primary side sense circuit and the primary side diode.

However, in the claimed systems, the secondary side current consumption information is galvanically isolated. Typically, the secondary side currents are regulated though the information provided to primary side by a link such as an opto-coupler. The use of an opto-coupler is an expensive approach and provides a weak link in the system to achieve accurate primary side regulation (PSR) in LED applications.

Typically, the conventional system uses an explicit Low pass filter (LPF) to correct the Peak Regulation Voltage (PRV) at the end of a half cycle for inherent filtering. Typically, the PRVs are corrected at multiple points within a half cycle using high correction frequency. The increase in correction frequency susceptible to high frequency errors or noises and needs adequate filtering in LED applications.

Hence, there is need for a system to achieve accurate primary side regulation. (PSR), Power Factor Correction (PFC), dimming functionality without the need of external components. Further, the method corrects the PRV of primary loop to meet desired half cycle reference voltage/current, which in turn achieves the desired secondary loop currents in led circuit using a firmware.

### SUMMARY OF THE INVENTION

The present invention overcomes the drawbacks in the prior art and provides a system and method to regulate primary side current using an event driven architecture in led circuit. The system comprises of an input module, a computing module, a subtractor module, a gain module, an accumulator module, an analog to digital module, a multiplier module, a digital to analog module, a Pulse Width Modulation (PWM) module, the power and current estimator module and a control module. The input module allows the user (s) to enter the desired. reference voltage as per the requirement through a reference block. The computing module is configured to compute the average half cycle power/current from an input supply line cycle to generate the average feedback half cycle Peak Regulation Voltage (PRV) using a filter average. The subtractor module is configured to receive the desired reference voltage and the average feedback half cycle PRV/current from the input module and computing module. In the preferred embodiment, the received desired reference voltage and average feedback half cycle PRV/current is calculated by calculating the difference therein to produce an error signal using a subtractor. The gain module receives the difference error signal from the subtractor module and boost up the loop response and speed of error correction in the error signal by adding the gain signal. The accumulator module is configured to accumulate the error signal from the gain module and determine the level of effective reference set point signal to ensure the average feedback half cycle PRV equaling to the desired reference voltage using an accumulator. The Analog to Digital Converter (ADC) module is configured to regulate and convert the primary peak voltage to the digital signal to realize the wave shaping using an Analog to Digital Converter (ADC). The multiplier module multiplies the output of the analog to digital module and the accumulator module using a multiplier. The multiplier module contains information of the primary peak voltage and level of error signal. The Digital to Analog converter (DAC) module receives and converts the digital signal from the multiplier module to the analog signal using a Digital to Analog Converter (DAC). The DAC establishes the desired set voltage by regulating the primary peak voltage of the analog signal. The control module is configured to control the secondary side LED currents by regulating the primary peak voltage using a switch. The controlled secondary side currents are allowed to flow through a sense resistor to generate a voltage, wherein the generated voltage is in form of saw tooth waveform. The saw tooth waveform enables the user(s) determine and calculate the turn ON time and turn OFF time of the switch to achieve regulation of secondary side currents by controlling the primary side currents.

In a preferred embodiment of the invention, the system further comprises of a Pulse Width Modulation (PWM) module to turn ON the switch when the output of the DAC is larger than the voltage from the sense resistor using a PWM converter.

In a preferred embodiment of the invention, the system further comprises of a power and current estimator module which is configured to determine the cycle by cycle power/current based on various factors such as the DAC set point, turn ON time of the switch and switching period of the switch.

In a preferred embodiment of the invention, the power and current estimator module further configured to determine the cycle by cycle power/current for both isolated system and non isolated system.

In a preferred embodiment of the invention, the system further comprises of a dim block, a thermal block and an input block, The dim block estimates the dimming duty cycle i.e. ON time and OFF time in the saw tooth waveform and in supply line frequency. The thermal block gives the thermal information of the outside electronic components such as LEDs and chips. The input block gives additional inputs to the system such as error correction or any other desired information as per the applications in the LED circuits.

In the preferred embodiment, the system further provides an offset error correction that may be added to the control loop to account for transformer ratio errors, inductor zero current errors and non linearity errors to improve the secondary side currents by controlling the primary side currents.

In the preferred embodiment, the system comprising a firmware module which is configured to work for each block to generate the response for one or more events and transmit the response via the event based module to operate at-least one of the block selected from the list of input module, the computing module, the suhtractor module, the gain module, the accumulator module, the ADC module, the multiplier module, the DAC module, the power and current estimator module, PWM converter module and the control module for LED applications.

According to another embodiment of the invention, the invention provides a method for regulating the primary side current using an event driven architecture in led circuit. In most preferred embodiment, the method includes the step oftriggering a switch by applying an analog signal to the gate terminal of the switch using a DAC. After triggering the switch, the time duration is calculated for the primary and secondary currents for each current cycle. After calculating the time duration, the area-cycle of the primary and secondary currents are manipulated that are fed into the LED applications. Further, the manipulations are repeated for each area cycle in the waveform. Finally, the total average current is computed by taking the summation of area-cycle(s) of the secondary currents divided by summation of time taken for each cycle(s).

In the preferred embodiment of the invention, the method further resets filter average currents when there is interruption using a firmware.

The present invention provides a system and method which is simple, time saving, resource efficient, and cost effective. The invention may be used in variety of applications as indicator lamps and in different types of lighting environments which uses LED's.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates a system to regulate primary side current using an event driven architecture in led circuit, according to one embodiment of the invention.

FIG. 2 illustrates the method for regulating the primary side current using an event driven architecture in led circuit, according to one embodiment of the invention.

FIG. 3 shows the saw tooth waveform illustrating the average feedback primary side current in the led circuit, according to one embodiment of the invention.

FIG. 4a shows the block diagram of the non-isolated system in the led circuit, according to one embodiment of the invention.

FIG. 4b shows the waveforms of non-isolated system in the led circuit, according to one embodiment of the invention.

FIG. 5a shows the block diagram of the isolated system in the led circuit, according to one embodiment of the invention.

FIG. 5b shows the waveforms of non-isolated system in the led circuit, according to one embodiment of the invention.

### DETAILED DESCRIPTION OF THE INVENTION

Reference will now be made in detail to the description of the present subject matter, one or more examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be Made within the scope of the embodiments. The following detailed description is, therefore, not be taken as limiting the scope of the invention, but instead the invention is to be defined by the appended claims.

The present invention discloses a system and method to regulate primary side current using an event driven architecture in led circuit. The system (100) performs a primary side regulation (PSR) of isolated or non-isolated [El) driver topology such as fly back system. The primary side peak voltage/current is regulated to achieve desired secondary side currents without the need of additional external components. The architecture combines firmware and hardware to realize PSR. The method (200) may effectively combine input wave shaping (Active PFC), dimming and PSR to achieve accurate secondary side currents. The method (200) corrects the Peak Regulation Voltage/current (PRV) of primary loop to meet desired half cycle reference voltage, which inturn achieves the desired secondary loop currents in led circuit.

The present invention provides a system and method which is simple, time saving, resource efficient, and cost effective. The invention may be used in variety of applications as indicator lamps and in different types of lighting environments hicl uses LED's.

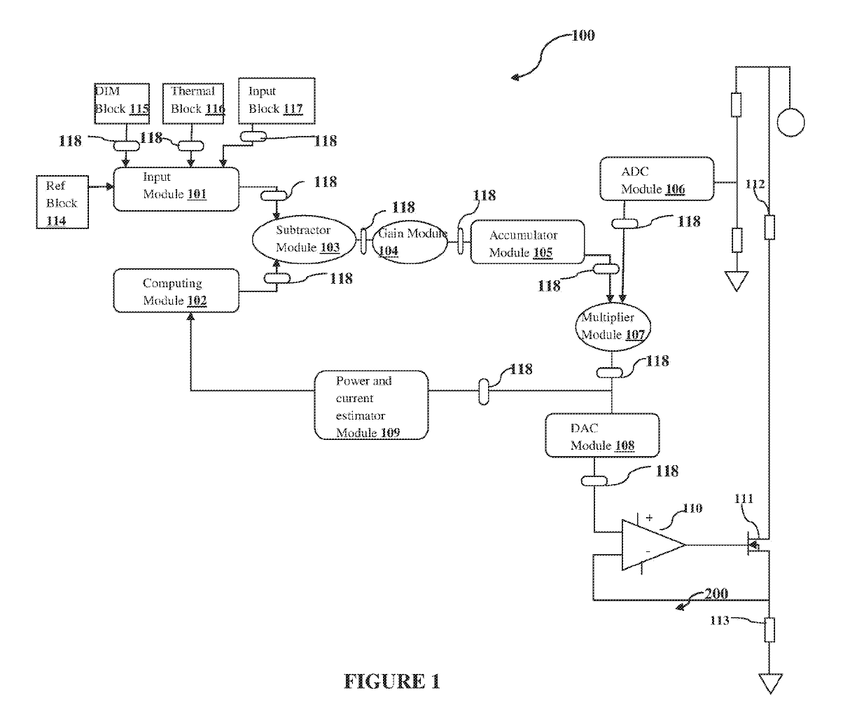

FIG. 1 illustrates a system to regulate primary side current using an event driven architecture in led circuit, according to one embodiment of the invention. In the most preferred embodiment, the system (100) comprises of an input module (101), a computing module (102), a subtractor module (103), a gain module (104), an accumulator module (105), an analog to digital module (106), a multiplier module (107), a digital to analog module (108), a Pulse Width Modulation (PWM) module (110), the power and current estimator module (109) and a control module. The input module (101) allows the user (s) to enter the desired reference voltage as per the requirement through a reference block (114). The computing module (102) is configured to compute the average half cycle power/current from an input supply line cycle to generate the average feedback half cycle Peak Regulation Voltage (PRV) using a filter average. The subtractor module (103) is configured to receive the desired reference voltage/current and the average feedback half cycle PRV from the input module (101) and computing module (102). In the preferred embodiment, the desired reference voltage and average feedback half cycle PRV is calculated by calculating the difference therein to produce an error signal using a subtractor. The gain module (104) receives the difference error signal from the subtractor module (103) and boost up the loop response and speed of error correction in the error signal by adding the gain signal. The accumulator module (105) is configured to accumulate the error signal from the gain module (104) and determine the level of effective reference set point signal to ensure the average feedback half cycle PRV equaling to the desired reference voltage using an accumulator. The Analog to Digital Converter (ADC) module (106) is configured to regulate and convert the primary peak voltage to the digital signal to realize the wave shaping using an Analog to Digital Converter (ADC). The multiplier module (107) multiplies the output of the analog to digital module and the accumulator module using a multiplier. The multiplier module (107) contains information of the primary peak voltage/current and level of error signal. The Digital to Analog converter (DAC) module (108) receives and converts the digital signal from the multiplier module to the analog signal using a Digital to Analog Converter (DAC). The DAC establishes the desired set voltage/current by regulating the primary peak voltage/current of the analog signal. The control module is configured to control the secondary side LED currents by regulating the primary peak voltage/current using a switch (112). The controlled secondary side currents is allowed to flow through a sense resistor (113) to generate a voltage, wherein the generated voltage is in forth of saw tooth waveform. The saw tooth waveform enables the user(s) determine and calculate the turn ON time and turn OFF time of the switch to achieve regulation of secondary side currents by controlling the primary side currents.

In the preferred embodiment, the firmware module (118) is configured to operate for each module. The firmware module (118) provides flexible operations for each module. The connection between each block in the system is done through the firmware module (118). The firmware module (118) provides wireless connection between each block in the system. The operation of each block remains same even though the position of each block is interchanged using the firmware module (118).

In the preferred embodiment, the system having the power and current estimator module (109) is configured to determine the cycle by cycle power/current based on various factors such as the DAC set point, turn ON time of the switch and switching period of the switch. Further, the power and current estimator module (109) is configured to determine the cycle by cycle power/current for both isolated system and non isolated system.

The system (100) further comprises of a dim block, a thermal block and an input block. The dim block (115), the thermal block (116) and the input block (117) updates and alerts the system (100) by inputting the various information. The dim block (115) estimates the dimming duty cycle i.e. ON time and OFF time in the saw tooth waveform and in the supply line frequency. The thermal block (116) gives the thermal information of the outside electronic components such as LEDs and chips. The input block (117) gives additional inputs to the system such as error correction or any other desired information as per the applications in the LED circuits.

In the preferred embodiment, the system (100) further provides an offset error correction that may be added to the control loop to account for transformer ratio errors, inductor zero current errors and other non linearity errors to improve the secondary side currents by controlling the primary sided currents.

In the preferred embodiment, the system (100) comprising a firmware module (118) which is configured to work for each block to generate the response for one or more events and transmit the response via the event based module to operate at-least one of the block selected from the list of the input module (101), the computing module (102), the subtractor module (103), the gain module (104), the accumulator module (105), the ADC module (106), the multiplier module (107), the DAC module (107), power and current estimator module (109), PWM converter module (110) and the control module for LED applications.

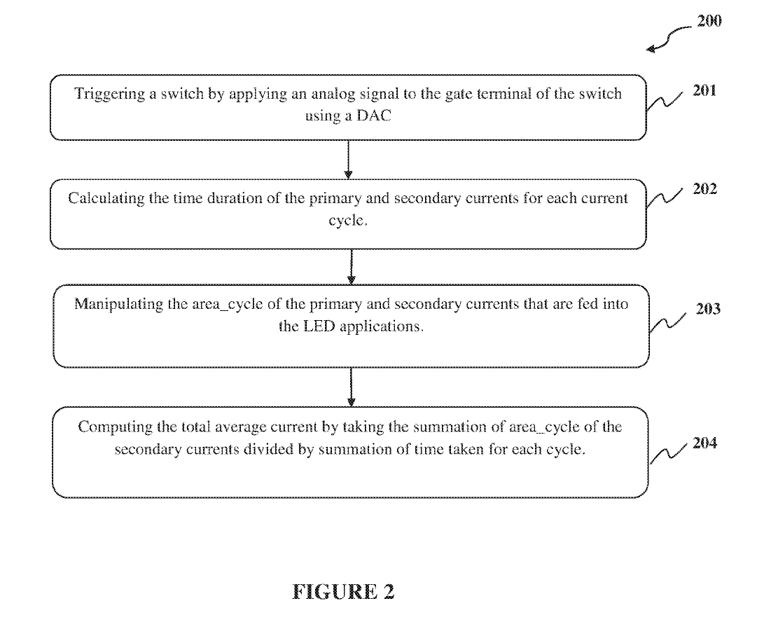

FIG. 2 illustrates the method for regulating the primary side current using an event driven architecture in led circuit, according to one embodiment of the invention. In the preferred embodiment, at step (201), a switch is triggered by applying an analog signal to the gate terminal of the switch using a DAC. After triggering the switch, at step (202), the time duration is calculated for the primary and secondary currents for each current cycle. After calculating the time duration, at step (203), the area-cycle of the primary and secondary currents are manipulating that are fed into the LED applications. In the preferred embodiment, the manipulations are repeated for each area cycle(s) in the waveform. Finally, at step (204), the total average current is computed by taking the summation of area-cycle(s) of secondary currents divided by summation of time taken for each cycle(s).

In the preferred embodiment, method achieves the accurate primary side regulation (PSR), Power Factor Correction (PFC), dimming functionality without the need of external components. The method regulates secondary loop currents by controlling the. PRV/currents of primary loop in led circuit using the below equations:

Error=Vset−{Σ[Vcycle peak*(Tcycle−TON)*0.5]}/(m*Σtcycle)

Where, Vset=Reference set voltage
Vcyclepeak =Set point for peak cycle
Tcycle=Switching cycle period

TON=Primary coil ON time

m=number of supply half cycles

### Effective Set Voltage=Error*Gain

Where,
gain is the system response used to achieve the overall system error correction
gain is realized in firm ware and is useful to cater system response for various operating conditions

### Average LED Secondary Currents=Vset/Rsense*n

Where,
Vset=Specified reference voltage constant
n=Transformer ratio
Rsense=Variable & is used to set the LED currents

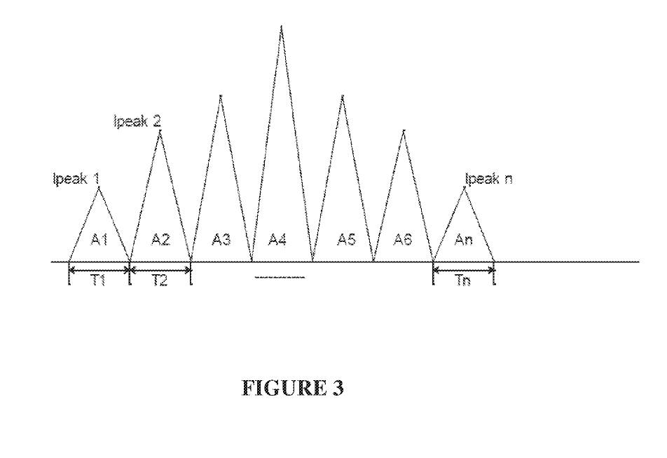

FIG. 3 shows the saw tooth waveform illustrating theaverage feedback primary side current in the led circuit, according to one embodiment of the invention. In the preferred embodiment, the saw tooth waveform indicates the cycle by cycle current limit and regulation details. The saw tooth waveform is used to calculate the average LED current. The average LED current for each cycle is calculated using the below equation:

Average LED current=(A1+A2+A3+A4+ . . . +An)/(T1+T2+ . . . +Tn)

Ax=(Ipeakx)=(Tx/2)

Where, Ax indicates the averaged primary side current.
Tx indicates the time in each switch cycle for secondary currents

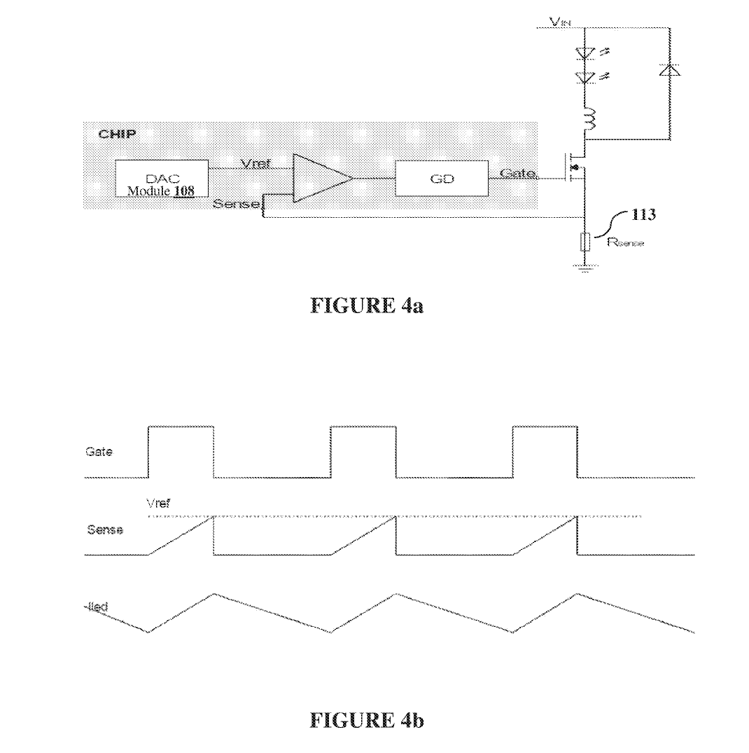

FIG. 4a shows the block diagram of the non-isolated system in the led circuit, according to one embodiment of the invention. In the preferred embodiment, the primary side and the secondary side of the transformer are not isolated i.e. they are connected together. Here, the DAC module (108) establishes the desired set voltage/current by regulating the primary and secondary peak voltages/currents of the analog signal. The controlled primary and secondary side currents are allowed to flow through a sense resistor (113) to generate a voltage, wherein the generated voltage is in form of saw tooth waveform. The saw tooth waveform enables the user (s) determine and calculate the turn ON time and turn OFF time of the switch to achieve regulation of secondary side currents by controlling the primary side currents. In the preferred embodiment, the non-isolated system regulates to ensure that the average inductor current is equal to average load current to determine charge current (Q=IT), whereas in conventional buck-boost transformers, the average inductor current is not be equal to average load current, wherein such conventional systems may be realized using the firmware module in the invented system.

FIG. 4b shows the waveforms of non-isolated system in the led circuit, according to one embodiment of the invention. In the preferred embodiment, the primary and secondary side currents for each cycle(s) are calculated using the below equations:

Vref/Rsense=(Sense(peak))/Rsense

Iled(peak)=Vref/Rsense

Average_Led_Currents=Iled(peak)/2

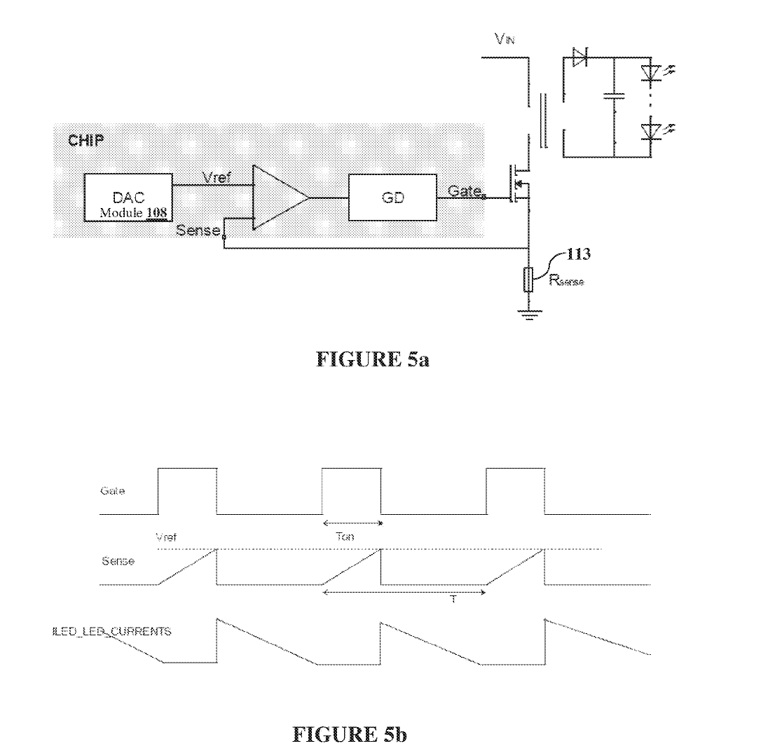

FIG. 5a shows the block diagram of the isolated system in the led circuit, according to one embodiment of the invention. In the preferred embodiment, the primary side and the secondary side of the transformer are isolated i.e. they are not connected together. Here, the DAC module (108) establishes the desired set voltage by regulating the primary peak voltage of the analog signal, which in turn the secondary peak voltage. The controlled primary and secondary side currents are allowed to flow through a sense resistor (113) to generate a voltage, wherein the generated voltage is in form of saw tooth waveform. The saw tooth waveform enables the user (s) determine and calculate the turn ON time and turn OFF time of the switch to achieve regulation of primary and secondary side currents. In the preferred embodiment_{;} the isolated system regulates to ensure that the average inductor current is equal to average load current to determine charge current (Q=IT), whereas in conventional buck-boost transformers the average inductor current is not be equal to average load current.

FIG. 5b shows the waveforms of non--isolated system in the led circuit, according to one embodiment of the invention. In the preferred embodiment, the primary and secondary side currents for each cycle are calculated using the below equations:

Vref/Rsense=Sense(peak)Rsense

Iind(peak)=Vref/Rsense

Average_Led_Currents=Iind(peak)*1/2, where D=Ton/T

The present invention provides a system and method which is simple, time saving, resource efficient, and cost effective. The invention may be used in variety of applications as indicator lamps and in different types of lighting environments uses LED's.

It is to be understood, however, that eventhough numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

We claim:

1) A system to regulate primary side current using an event driven architecture in led circuit, the system (100) comprises of:
a. an input module (101) allows the user(s) to enter the desired reference voltage as per the requirement through a reference block;
b. computing module (102) configured to compute the average half cyclepower/current from a input supply line cycle to generate the average feedback half cycle Peak Regulation Voltage (PRV) using a filter average;
c. a subtractor module (103) receives the desired reference voltage and the average feedback half cycle PRV from the input module and computing module, wherein the desired reference voltage and average feedback half cycle PRV is calculated by calculating the difference therein to produce an error signal using a subtractor;
d. a gain module (104) receives the difference error signal from the subtractor module and boost up the loop response and speed of error correction in the error signal by adding the gain signal;
e. an accumulator module (105) configured to accumulate the error signal from the gain module and determine the level of effective reference set point signal to ensure the average feedback half cycle PRV/current equalling to the desired reference voltage using an accumulator;
f. an analog to digital converter (ADC)(106) module configured to regulate and convert the primary peak voltage to the digital signal to realize the wave shaping using an Analog to Digital Converter (ADC);
g. a multiplier module (107) multiplies the output of the analog to digital module and the accumulator module using a multiplier, wherein the multiplier module contains information of the primary peak voltage and level of error signal;
h. a digital to analog converter (DAC) (108) module receives and converts the digital signal from the multiplier module to the analog signal using a Digital to Analog Converter (DAC), wherein the DAC establishes the desired set voltage/current by regulating the primary peak voltage/current of the analog signal; and
i. a control module configured to control the secondary side LED currents by regulating the primary peak voltage using a switch (111), wherein the controlled secondary side currents is allowed to flow through a sense resistor (113) to generate a voltage, wherein the generated voltage is in form of saw tooth waveform, wherein the saw tooth waveform enables the user(s) determine and calculate the turn ON time and turn OFF time of the switchto achieve regulation of secondary side currents by controlling the primary side currents.

2) The system as claimed in claim 1, wherein thesystem further comprises of a Pulse Width Modulation (PWM) module (110) to turn ON the switch when the output of the DAC is larger than the voltage from the sense resistor using a PWM converter.

3) The system as claimed in claim 1, wherein the system further comprises of a power and current estimator module (109) configured to determine the cycle by cycle power/current based on various factors such as the DAC set point, turn ON time of the switch and switching period of the switch.

4) The system as claimed in claim I, wherein the power and current estimator module (109) further configured to determine the cycle by cycle power/current for both isolated system and non isolated system.

5) The system as claimed in claim 1, wherein the system (100) further comprises of a dim block (115), a thermal block (116) and an input block (117), wherein the dim block (115) estimates the dimming duty cycle i.e. ON time and OFF time in the saw tooth waveform and in supply line frequency, wherein the thermal block (116) gives the thermal information of the outside electronic components such as LEDs and chips, wherein the input block (117) gives additional inputs such as error correction or any other desired information as per the applications in the LED circuits.

6) The system as claimed in claim 1, wherein the system (100) further provides an offset error correction that may be added to the control loop to account for transformer ratio errors, inductor zero current time errors and other non linearity errors to improve the secondary side currents by controlling the primary side currents.

7) The system as claimed in claim 1, wherein the system (100) further provides the ability to realize the transfer function to regulate the output in both isolated and non isolated system using the firmware module.

8) A system for active power factor correction in led circuit, the system (100) comprises of:
a. a firmware module (118) configured to work for each block to generate the response for one or more events and transmit the response via the event based module to operate at-least one of the block selected from the list of input module (101), the computing module (102), the subtractor module (103), the gain module (104), the accumulator module (105), the ADC module (1(6), the multiplier module (107), the DAC module (107), power and current estimator module (109), PWM converter module (110) and the control module for LED applications.

9) A method to regulate primary side current using an event driven architecture in led circuit, the method (200) comprising:
a. triggering a switch by applying an analog signal to the gate terminal of the switch using a DAC (201);
b. calculating the time duration of the primary and secondary currents for each current cycle (202);
c. manipulating the area_cycle of the primary and secondary currents that are fed into the LED applications (203); and
d. Computing the total average current by taking the summation of are_cycle(s) of the secondary currents divided by summation of time taken for each cycle(s) (204).

10) The method as claimed in claim 8, wherein the method further calculates area of currents/charge through at-least two parameters selected from the list of TON, TOFF and Total time (TON+TOFF) which is obtained during switching operation, wherein the calculated area of currents/charge is regulated through firmware module (118), wherein the TOFF time in the secondary side is calculated by using TON and Total time.
